(19) United States
(12) Patent Application Publication
(10) Pub. No.: US 2010/0235128 A1
(43) Pub. Date: Sep. 16, 2010

(54) MEASURING DEVICE, IN PARTICULAR DISTANCE MEASURING DEVICE

(76) Inventors: Peter Wolf, Leinfelden-Echterdingen (DE); Uwe Skultety-Betz, Leinfelden-Echterdingen (DE); Joerg Stierle, Waldenbuch (DE); Bjoern Haase, Stuttgart (DE); Kai Renz, Leinfelden-Echterdingen (DE)

Correspondence Address: MICHAEL J. STRIKER, 103 EAST NECK ROAD, HUNTINGTON, NY, 11743, US

(21) Appl. No.: 12/160,350

(22) PCT Filed: Jan. 11, 2007
(86) PCT No.: PCT/EP07/50267

§ 371 Date: Jun. 1, 2010

(30) Foreign Application Priority Data
Jan. 13, 2006 (DE) 102006001964.4

(51) Int. Cl. G01C 25/00; G01B 11/14

(52) U.S. Cl. 702/97; 702/159

(57) ABSTRACT

The invention is based on a measuring device, in particular a distance measuring device, having a transmission unit (18) for transmitting a measurement signal (22) and a processing unit (30) which is intended to process the measurement signal (22) and has a frequency response (70) having a first resonant frequency range (76) in which the measurement signal (22) is arranged. The invention proposes that the frequency response (70) has at least one second resonant frequency range (78) in which the measurement signal (22) is arranged during a measurement.

### PRIOR ART

The invention is based on a measuring device, in particular a distance measuring device, having a transmitter unit as generically defined by the preamble to claim 1.

Measuring devices are known that for measuring a distance from an object being measured transmit a measurement signal at a measurement frequency. This measurement signal is received by the measuring device after being reflected from the object being measured. For evaluating distance information that is carried by the received measurement signal, the measurement signal is processed with an auxiliary signal and converted into an evaluation signal. The auxiliary signal has a frequency that can be adapted to the measurement frequency used by adaptation of the resonant frequency of an oscillating circuit.

### ADVANTAGES OF THE INVENTION

The invention is based on a measuring device, in particular a distance measuring device, having a transmitter unit for transmitting a measurement signal and a processing unit for processing the measurement signal, which unit has a frequency response with a first resonant frequency range in which the measurement signal is located.

It is proposed that the frequency response has at least one second resonant frequency range, in which the measurement signal is located upon a measurement. As a result, the precision of a measurement process can advantageously be increased. If the measuring device is embodied as a distance measuring device, then high resolution, in particular, as well as a long range in a distance measurement can be attained. High flexibility in use of the measuring device can be attained as well. For instance, the measuring device can be embodied as a locating device, and the resonant frequency ranges can be used to detect various substances in various frequency ranges. In measurement, the measurement signal is preferably transmitted to an object being measured. The measurement signal, carrying information about the object being measured that is reflected by the object being measured, such as distance information, and received by the measuring device is advantageously supplied to the processing unit, which can process the measurement signal, for instance into an evaluation signal for evaluation of the information. For processing the measurement signal, at least one oscillating variable is expediently used in the processing unit. This oscillating variable is for instance embodied as an oscillating voltage and/or oscillating current. The frequency response serves preferably to characterize a processing operation that is performed by means of the oscillating variable, as a function of the oscillation frequency. The frequency response in particular characterizes a device, in particular an electrical device, that is used to perform the processing operation. In this connection, the frequency response preferably represents a ratio between an output signal, which is excited by an input signal fed to the device, and the input signal, as a function of the frequency. The device can serve to transmit an oscillating variable, such as an oscillating voltage, an oscillating current, and so forth. The device can furthermore serve to convert an oscillating variable into a further oscillating variable. For instance, as its output signal, the device can generate an oscillating voltage from an oscillating current acting as the input signal. The frequency response corresponds in particular to the frequency spectrum of an output signal excited by a dirac pulse, that is, an infinitely sharp pulse. The term “resonant frequency range” of a frequency response is to be understood in this connection to mean in particular a range of the frequency response which extends about a resonant frequency of the frequency response. The width of this frequency range can amount at least to 10%, for instance, advantageously at least 20%, and preferably at least 30% of the resonant frequency.

Preferably, the processing unit is provided for a tuning-free mode of operation. As a result, a measuring time can advantageously be reduced. With the aid of a tuning-free mode of operation, a measurement can be performed without requiring that a characteristic of the processing unit, such as a value of an electronic component of the processing unit, be adapted to a condition of the measurement.

It is also proposed that the processing unit is intended for processing the measurement signal by means of an auxiliary signal in order to generate an evaluation signal. As a result, measurement information carried by the measurement signal can be drawn with high flexibility, for instance for controlling the auxiliary signal, from the measurement signal for evaluation. Advantageously, the measurement signal can be mixed with the auxiliary signal in the processing unit, as a result of which an evaluation signal that is suitable, for instance in its frequency, for evaluation can be generated especially simply.

In an advantageous embodiment of the invention, it is proposed that the measuring device has a receiver unit for receiving the measurement signal, in which unit, in operation, the measurement signal is mixed with an auxiliary signal. As a result, an especially compact construction of the processing unit can be attained.

It is furthermore proposed that the processing unit includes a filter device, which has the frequency response. Frequencies that interfere with processing the measurement signal can advantageously be suppressed, and as a result the measurement quality can be enhanced. In processing a signal that has an oscillating variable, the variable can be converted into a further oscillating variable. For instance, the filter device can convert an oscillating current signal into an oscillating voltage signal. The filter device is embodied for instance as a frequency filter. The filter device can furthermore be embodied as an adaptation filter that is intended for adapting a signal power of a signal supplied to the filter device.

In this connection, it is proposed that the processing unit is intended for processing the measurement signal by means of the auxiliary signal, and the filter device serves to filter the auxiliary signal. As a result, an especially effective processing process of the measurement signal can be attained. The measurement signal is transmitted in the course of a measurement operation in a plurality of measurement frequency ranges, for instance, that are selected purposefully for high measurement precision. The auxiliary signal can be adapted to a preferred measurement frequency range of the measurement signal in a simple way by associating each of the resonant frequency ranges of the frequency response to a particular measurement frequency range of the measurement signal.

If the filter device includes an at least third-order filter circuit, then especially effective suppression of unwanted frequencies can be attained. The order of a filter circuit in particular describes the decrease in the amplitude ratio of an output signal, which is excited by an input signal supplied to the filter circuit, to the input signal above or below a limit frequency that characterizes a bandpass width of the filter circuit. If n is the order of the filter circuit, then the decrease n amounts for instance to 20 dB per frequency decade. If the filter circuit is of a higher order, such as the fourth, fifth, or higher order, then the resonant frequency ranges of the frequency response can moreover be generated with high flexibility.

In a further embodiment, it is proposed that the measurement signal is embodied as a bandwidth signal; as a result, high information density and thus high precision in processing, especially in evaluating the measurement signal, can be attained. The measurement signal can simultaneously have a plurality of sharp measurement frequencies within one measurement frequency range. Moreover, the measurement signal can have a continuum of measurement frequencies that extends over one measurement frequency range.

In this connection, it is proposed that the processing unit is intended for processing the measurement signal by means of an auxiliary signal which is embodied as a bandwidth signal. As a result, processing, and in particular optimized utilization of measurement information in the measurement signal, can be attained that is advantageously adapted to the embodiment of the measurement signal as a bandwidth signal.

It is furthermore proposed that the measuring device have an at least partly automatic calibration mode, in which a measurement frequency range for the measurement signal is adapted to at least one of the resonant frequency ranges, which offers an advantageous enhancement of the measurement quality.

In this connection, it is proposed that the measuring device have a calibration course, by way of which the measurement signal is fed as a calibration signal in the calibration mode to the processing unit; by a measuring unit, which is intended for a resonance measurement of the resonant frequency ranges by means of the calibration signal; and by a control unit, which is intended for adapting the measurement frequency range to at least one of the resonant frequency ranges as a function of the resonance measurement. As a result, especially simple execution of a calibration process in the calibration mode can be attained. Moreover, an existing course, which serves the purpose of a reference measurement, for instance, can advantageously be used.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1, a laser distance measuring device, located in front of an object being measured, with a transmitter unit for transmitting a measurement signal and with a processing unit for processing the reflected measurement signal;

FIG. 2, a signal generating unit, a filter device, and a receiving unit of the processing unit of FIG. 1;

FIG. 3, a frequency response of the filter device of FIG. 2 with sharp measurement signals; and

FIG. 4, the frequency response with a measurement signal embodied as a bandwidth signal.

### DESCRIPTION OF THE EXEMPLARY EMBODIMENTS

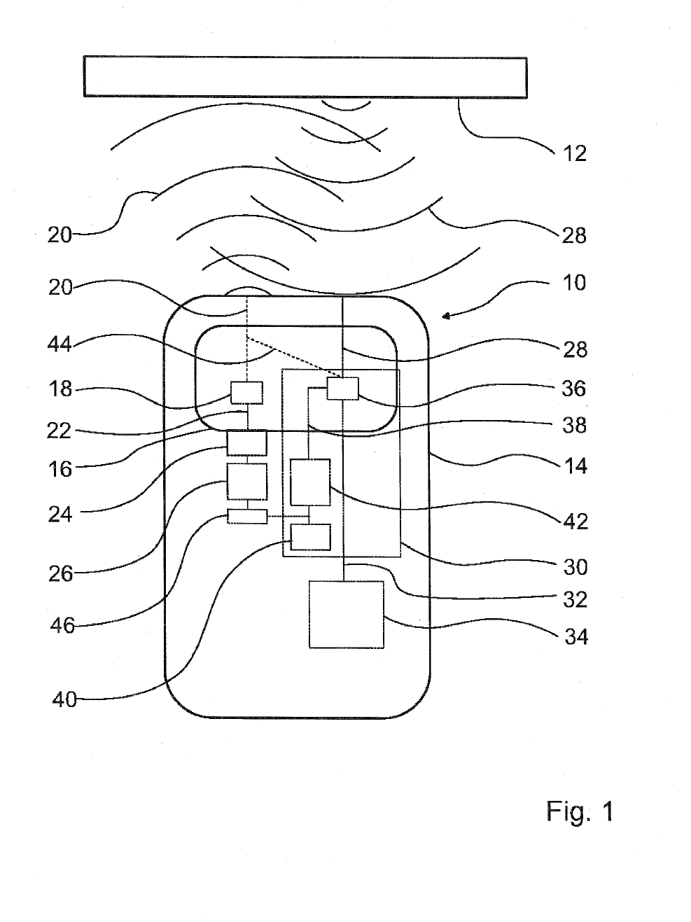

FIG. 1 shows a laser distance measuring device 10, which performs a measurement of the distance from an object 12 being measured. The laser distance measuring device 10 has a housing 14, a display 16, and actuation elements, not shown, for turning operation on and off and for starting and configuring a measurement operation. Inside the housing 14, there is a transmitter unit 18 for generating a transmission signal 20. In this example, the transmission signal 20 is embodied as a beam of light. A version of the transmission signal 20 as an acoustical signal, such as an ultrasound signal, is equal conceivable. The transmitter unit 18 in this example is embodied as a laser diode. Upon transmission, the amplitude of the light in the transmission signal 20 is modulated by a measurement signal 22. The measurement signal 22, which is a high-frequency signal, is produced by a signal generating unit 24, embodied as an oscillator, and is supplied to the transmitter unit 18 for modulating the light in the transmission signal 20. The signal generating unit 24 is controlled by a control unit 26. The transmission signal 20, reflected by a surface of the object 12 being measured, is received via reception optics, not shown, as a received signal 28 by the laser distance measuring device 10. Upon reception of the received signal 28, the measurement signal 22, which modulates the light amplitude of the received signal 28, has a phase displacement that is proportional to the light transit time between the transmission of the transmission signal 20 and the reception of the received signal 28. This phase displacement represents distance information. The laser distance measuring device 10 has a processing unit 30, which is provided for processing the measurement signal 22 into an evaluation signal 32. The evaluation signal serves to evaluate the distance information into the desired distance, which is performed in an evaluation unit 34.

The processing unit 30 has a receiver unit 36 for receiving the received signal 28; this unit is embodied for instance as a photodiode, in particular as an APD (Avalanche Photodiode). On reception of the received signal 28, the receiver unit 36 generates an electrical signal, which is proportional to the amplitude of the received light and thus represents the measurement signal 22 that modulates the light. The evaluation signal 32 is generated by a mixture of the thus-acquired measurement signal 22 with an auxiliary signal 38 of shifted frequency. The frequency difference is selected such that the evaluation signal 32 is a low-frequency signal that is suitable for evaluating the distance information. The mixing is done by multiplication of the measurement signal 22 by the auxiliary signal 38 and preferably takes place inside the receiver unit 36 embodied as a photodiode. The processing unit 30 furthermore has a signal generating unit 40 for generating the auxiliary signal 38 and a filter device 42 for filtering this auxiliary signal 38. The laser distance measuring device 10 is moreover provided with a calibration course 44, by way of which, for the sake of calibration, the transmission signal 20 transmitted by the transmitter unit 18 can be supplied directly to the receiver unit 36. In the calibration, the transmission signal 20 is deflected (not shown) by a deflection element, preferably embodied as a drivable flap, that can be moved by the control unit 26 into the path provided for the transmission signal 20. The laser distance measuring device 10 furthermore includes a measuring unit 46, whose function will be described below.

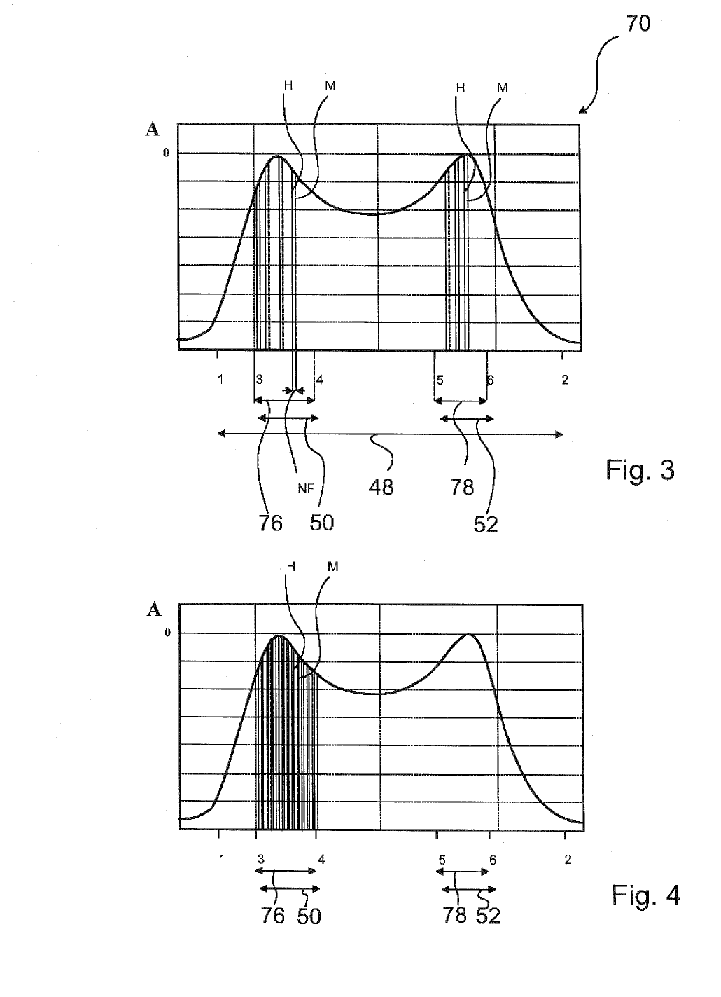

To attain high resolution in the measurement of the distance sought, the measurement signal 22 has a high measurement frequency v_{M} (see FIG. 3). A period (the interval from 0 to 2π) of the phase displacement between the transmitted and the received state of the measurement signal 22 is thus equivalent to a nonambiguity range, in which the distance can be determined unambiguously and which amounts to a few centimeters. To enable attaining greater nonambiguity ranges, a plurality of measurement frequencies v_{M} are employed, which for instance are located next to one another with a small frequency difference. In practice, more than two different measurement frequencies v_{M} will be used for the measurement signal 22. In this exemplary embodiment, the measurement frequencies v_{M} are selected within a frequency range 48 of from 750 MHz to 1050 MHz (see FIG. 3), which offers an especially advantageous increase in precision in the distance measurement. Within this frequency range 48, the measurement frequencies v_{M} are preferably selected in preferred measurement frequency ranges, such as measurement frequency ranges 50, 52, which are shown in FIG. 3.

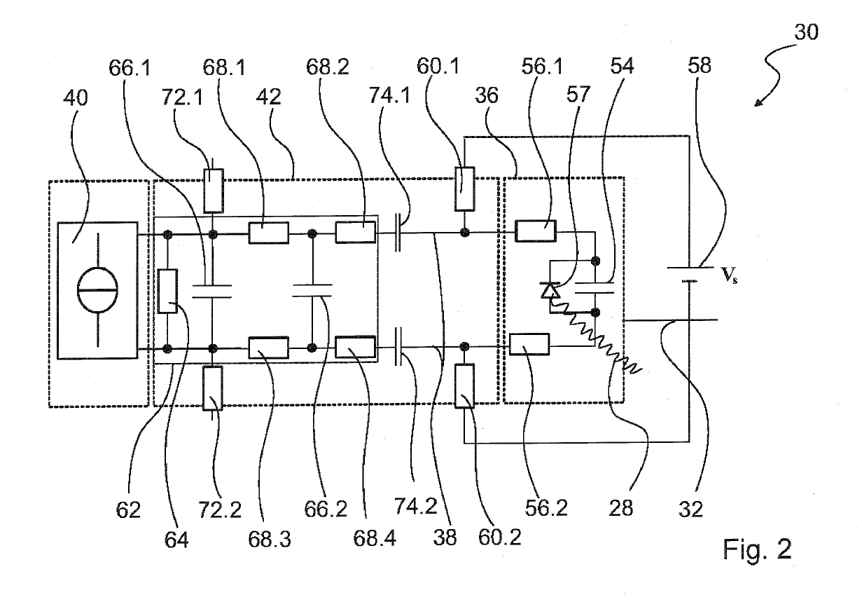

In FIG. 2, the disposition of the signal generating unit 40, filter device 42, and receiver unit 36 is shown in detail. The receiver unit 36, embodied as an APD, has an intrinsic capacitance as well as an intrinsic inductance, which are represented schematically in the drawing by a capacitor 54 and inductive resistors 56.1, 56.2. The photodiode 57 shown should thus be considered an ideal photodiode. The construction and functional principle of an APD are known and will not be repeated in the context of this description. In operation, a high direct voltage Vₛ, which in this example amounts to 150 Volts, is applied to the barrier junction of the receiver unit 36 embodied as an APD. This is done via a voltage supply 58, shown in dashed lines, and electrical resistors 60.1, 60.2. These resistors additionally serve to decouple the measurement signal 22, received by the receiver unit 36, from the voltage supply 58. The direct voltage Vₛ is modulated in operation with the auxiliary signal 38. As a result, the auxiliary signal 38 is mixed with the received measurement signal 22, and as a result the low-frequency evaluation signal 32 is generated.

In this exemplary embodiment, the signal generating unit 40 is embodied as a differential current source. Accordingly, the filter device 42 shown has a differential construction, and the auxiliary signal 38 is applied as a differential voltage signal to the barrier of the receiver unit 36 embodied as an APD. In a variant embodiment, it is equally conceivable to use a unipolar signal generating unit 40 and a unipolar filter device 42.

The filter device 42 has a filter circuit 62. This circuit, with a resistor 64, capacitors 66.1, 66.2, and inductive resistors 68.1, 68.2, 68.3, 68.4, forms a fifth-order filter circuit. As a result of this filter circuit 62, the filter device 42 has a frequency response 70 that is shown in FIG. 3. For determining the suitable values for the components of the filter circuit 62, the intrinsic capacitance 54 and the intrinsic inductances 56.1, 56.2 of the receiver unit 36 embodied as an APD are determined by means of a measurement and taken into account. Inductive resistors 72.1, 72.2 and capacitors 74.1, 74.2 are incorporated into the filter device 42 as well. The capacitors 74.1, 74.2 serve to decouple the filter circuit 62 from the voltage supply 58. The inductive resistors 72.1, 72.2 serve to set the operating point of the signal generating unit 40, embodied as a differential current source. This current source, in this example, is embodied as a transistor, in which a voltage is applied to the collector. The inductive resistors 72.1, 72.2 serve to maintain this voltage within a defined work interval, such as between 1.5 V and 4.5 V, specifically independently of the added filter circuit 62. The inductive resistors 72.1, 72.2 and the capacitors 74.1, 74.2 are selected such that they have no influence on the frequency response 70 shown in FIG. 3. The filter circuit 62 shown is embodied as a passive filter circuit. In a variant embodiment, it is conceivable to use an active filter device. This is especially advantageous if frequencies up to 100 MHz, for instance, are used for the auxiliary signal 38.

In FIG. 3, the frequency response 70 of the filter circuit 62 in FIG. 2 is shown. The amplitude ratio A of an output signal, which is excited by an input signal supplied to the input of the filter circuit 62, to the input signal is shown in dB (decibels) as a function of the frequency v in MHz (Megahertz). The line “0” represents transmission of the input signal without damping. The filter circuit has a lower limit frequency v₁=750 MHz and upper limit frequency v₂=1050 MHz. The frequency range defined by these limits corresponds to the frequency range 48, in which the measurement frequencies v_{M} are selected. Below the lower limit frequency v₁ and above the upper limit frequency v₂, a signal is suppressed by the filter circuit 62. The frequency response 70 furthermore has two resonant frequency ranges 76, 78, which are formed by the frequency intervals from v₃=800 MHz to v₄=840 MHz and from v₅=940 MHz to v₆=990 MHz. The frequency response 70 corresponds to the output signal excited by a dirac pulse as the input signal. In practice, the frequency response 70 can be measured by sampling the frequency range 48 between v₁ and v₂, by supplying a sharp-frequency signal of increasing frequency, such as with an increment of 1 MHz, to the filter circuit 62 and acquiring the corresponding output signal. The filter device 42 shown in FIG. 2 can have a varying frequency response 70, by means of a suitable choice of the values of its electronic components or by a further mode of connection, and this frequency response for instance has more than two resonant frequency ranges.

In measuring a distance, the transmission signal 20 is modulated with the measurement signal 22, which has a measurement frequency v_{M}. The measurement signal 22 received by the receiver unit 36 is mixed with the auxiliary signal 38 filtered by the filter device 42, and this signal has a mixed frequency v_{H}=v_{M}−v_{NF}; v_{NF} is a low frequency and represents the desired evaluation frequency of the evaluation signal 32. The measurement frequencies v_{M} used are preferably selected within the measurement frequency ranges 50, 52. These ranges each correspond at least in part to one of the resonant frequency ranges 76 and 78 of the filter circuit 62, and as a result a high mixed gain can be attained. The resonant frequency ranges 76, 78 themselves, because of the suitable construction of the filter circuit 62, are located in ranges in the frequency scale in which the measurement frequencies v_{M} are to be selected, for optimizing the measurement precision and the range of the distance measurement. Moreover, the measurement precision increases with the number of measurement frequencies v_{M} used. In the drawing, as an example, four values for the measurement frequency v_{M} are shown in dashed lines. Each value of the measurement frequency v_{M} is assigned the corresponding mixed frequency v_{H}, which is shifted by the evaluation frequency v_{NF}. In the measurement, the measurement frequency v_{M} can be selected both in the measurement frequency range 50 and in the measurement frequency range 52. Compared to an embodiment of the filter device 42 with a conventional second-order filter circuit, which has a frequency response with only one resonant frequency range, the measurement frequency v_{M} an be selected in both measurement frequency ranges 50, 52, without requiring that the filter circuit 62 be tuned for the sake of mixing the measurement signal 22 with the auxiliary signal 38. The filter circuit 62 shown in FIG. 2, by a suitable choice of its electronic components, makes both resonant frequency ranges 76, 78 available at any time, and tuning of a value of one or more components of the filter circuit 62 for adaptation of the auxiliary signal 38 to a measurement frequency v_{M} used in the measurement signal 22 can be dispensed with.

In FIG. 4, the frequency response 70 of the filter circuit 62 shown in FIG. 2 is shown once again. In conjunction with this drawing, a further exemplary embodiment will be explained, in which the measurement signal 22 is embodied as a bandwidth signal. The measurement signal 22 simultaneously has a plurality of measurement frequencies v_{M}, which are located within the measurement frequency range 50. It can likewise be located in the measurement frequency range 52. The measurement signal 22 can moreover have a continuum of measurement frequencies v_{M}, which each extend over a respective measurement frequency range 50 and 52. The measurement signal 22 is mixed with the auxiliary signal 38, which likewise is embodied as a bandwidth signal. To that end, the signal generating unit 40 is provided for generating the auxiliary signal 38 in a frequency band that in this example is formed by the respective resonant frequency range 76 and 78.

The laser distance measuring device 10 is furthermore provided with a calibration mode. In this calibration mode, the transmission signal 20, generated by the transmitter unit 18 and modulated with the measurement signal 22, is sent over the calibration course 44 to the receiver unit 36 of the processing unit 30. The measurement signal 22 serves as the calibration signal, which has a calibration frequency. In the course of the calibration mode, this calibration frequency is varied in increments, for instance with an increment of 1 MHz, by the control unit 26 between the limit frequency v₁ and the limit frequency v₂ (see FIG. 2). The calibration signal, received by the receiver unit 36 and transmitted via the filter circuit 62, is recorded by the measuring unit 46, which thus performs a resonance measurement by which the resonant frequency ranges 76, 78 of the filter circuit 62 are measured. From this resonance measurement, the control unit 26 can adapt the measurement frequency ranges 50, 52 for the measurement signal 22 to the resonant frequency ranges 76, 78 of the filter circuit 62 with high precision, and as a result an especially effective mixing method in the measurement can be attained. The calibration mode can be performed fully automatically, for instance upon turning on the laser distance measuring device 10. Alternatively, it can be switched on by a user.

1. A measuring device, in particular a distance measuring device, having a transmitter unit (18), for transmitting a measurement signal (22), and a processing unit (30) for processing the measurement signal (22), which processing unit has a frequency response (70) with a first resonant frequency range (76) in which the measurement signal (22) is located, characterized in that the frequency response (70) has at least one second resonant frequency range (78), in which the measurement signal (22) is located upon a measurement.

2. The measuring device as defined by claim 1, characterized in that the processing unit (30) is intended for a tuning-free mode of operation.

3. The measuring device as defined by claim 1, characterized in that the processing unit (30) is intended for processing the measurement signal (22) by means of an auxiliary signal (38) in order to generate an evaluation signal (32).

4. The measuring device as defined by claim 1, characterized in that the processing unit (30) includes a filter device (42), which has the frequency response (70).

5. The measuring device as defined by claim 4, characterized in that the processing unit (30) is intended for processing the measurement signal (22) by means of the auxiliary signal (38), and the filter device (42) serves to filter the auxiliary signal (38).

6. The measuring device as defined by claim 4, characterized in that the filter device (42) includes an at least third-order filter circuit (62).

7. The measuring device as defined by claim 1, characterized in that the measurement signal (22) is embodied as a bandwidth signal.

8. The measuring device as defined by claim 7, characterized in that the processing unit (30) is intended for processing the measurement signal (22) by means of an auxiliary signal (38) which is embodied as a bandwidth signal.

9. The measuring device as defined by claim 1, characterized by an at least partly automatic calibration mode, in which a measurement frequency range (50, 52) for the measurement signal (22) is adapted to at least one of the resonant frequency ranges (76, 78).

10. The measuring device as defined by claim 9, characterized by a calibration course (44), by way of which the measurement signal (22) is fed as a calibration signal in the calibration mode to the processing unit (30); by a measuring unit (46), which is intended for a resonance measurement of the resonant frequency ranges (76, 78) by means of the calibration signal; and by a control unit (26), which is intended for adapting the measurement frequency range (50, 52) to at least one of the resonant frequency ranges (76, 78) as a function of the resonance measurement.
